(19) United States
(12) Patent Application Publication
(10) Pub. No.: US 2010/0263463 A1
(43) Pub. Date: Oct. 21, 2010

(54) Gyro Stabilization System for Suspended Platform

(75) Inventor: Zbigniew Janosik, Cedar Grove, NJ (US)

Correspondence Address: Zbigniew Janosik, 42 Briar Hill Rd., Cedar Grove, NJ, 07009, US

(73) Assignee: Zbigniew Janosik, Cedar Grove, NJ (US)

(21) Appl. No.: 11/759,224

(22) Filed: Jun. 6, 2007

(51) Int. Cl. G01C 19/02; G01C 19/04

(52) U.S. Cl. 74/5.4

(57) ABSTRACT

A stabilization apparatus and a method for controlling stability of a suspended platform are described. System includes pivotally mounted gyro with an axis of rotation substantially orthogonal to the suspended platform's plane and adapted with the use of servos to convert precession of the gyro into a tilt of the platform. Described stabilization apparatus works in combination with the platform's main propulsion system. Apparatus is capable of providing high level stability for pitch, roll and yaw angles.

Platform's orientation control can be optimized by changing modes of operation to control at any time any two of three angles defining position of the suspended platform.

It would be advantageous to use such stabilized suspended platform as a camera pod and also in the flying models industry. Idea can be accommodated in the personal transportation vehicles, robotic vehicles both in airspace and outer space.

### BACKGROUND

Matter in the nature can be found in the form of solid, gas, fluid or plasma. This invention will be dealing with solid bodies suspended in non solid environment or vacuum. The brute force gyro is a large gyro used to directly stabilize a craft that it is mounted on. Unstable environment is environment in which random and unpredictable forces are affecting matter. The suspended platform or the flying platform is a solid object with the propulsion system in the form of a reactionary lifting means. The reactionary lifting means, the lifting means or the lift system is a lift and movement providing apparatus in some form of a fan, a ducted fan, a rocket motor, a jet motor or any other non-direct solid to solid contact. The suspended platform plane or the flying platform plane is the horizontal plane defined by the body of the platform in the state of suspension and motionless in relation to the ground, generally orthogonal to the thrust vector of the platform as a means of suspension.

Stability of a suspended solid body in a non-solid, unstable environment in reference to another solid body is difficult to achieve. For example, the case of a flying platform and specifically the platform where the center of gravity coincides with the thrust vector. In this invention to the flying platform is attached a stabilization apparatus, heart of which is the brute force gyro pivotally mounted with two degrees of freedom in the pitch and roll axel. In this embodiment vector of momentum of the gyro is kept substantially perpendicular to the plane of the flying platform. This is achieved by varying the thrust vectors of the platforms lift system that in turn will force the brute force gyro to precess in required direction. Pitch and roll of the platform is controlled by at least two servos, mounted nominally perpendicular to each other and in the plane of the flying platform. Servos are placed between the body of the flying platform and the spin axis of the gyro. Overall, the system provides a level of stability for pitch and roll comparable to the accuracy of the servos used. Yaw of the flying platform will be slightly affected by the effort of holding pitch and roll stable but depending on the system that can be minimized or virtually eliminated.

Prior Art shows many ways of controlling stability of a suspended solid body, most of them are involving changing the direction or magnitude of the vector of thrust, some are using brute force gyros for more direct control. Invention described here is based on the latter method therefore prior art described here concentrates on controlling stability with the use of a large gyro. Generally stabilization of a flying platform is achieved by holding the spin axis of a gyro in near vertical position and along with it plane of the platform is kept horizontal. Most similarities of mentioned idea and this invention are visible in U.S. Pat. No. 3,985,320. Disadvantage of described system is a necessity of holding the craft horizontally and a need for physical shifting ballast. Some devices have gyroscopic air foil attached to the lifting fan. Good example of such device can be found in U.S. Pat. No. 5,421,538. Here gyroscopic device is placed in the air stream of the lifting fan and has slight tilting abilities to work against the crafts fuselage with the use of servos. Control range of the gyroscopic device is limited in the described patent. Thrust vector for lift and stabilizing momentum from the gyro are not independent, thereby difficult to interact with each other. Another example of prior art is U.S. Pat. No. 6,789,437. Device described here is gimbals mounted, with servos purposely precessing the gyro to the required position. Device controls pitch and yaw.

### SUMMARY OF THE INVENTION

It is described here how to accurately control angular stability of a solid body, with the use of servos, connected to another solid body suspended in a reference to a third solid body. In the embodiment described here it would be controlling angular stability of a flying platform in reference to the ground. The flying platform would be connected by servo systems to a mechanical damper which in this case is a brute force gyro. The brute force gyro is mounted inside the apparatus with two degree of freedom, one for pitch and other for roll. In this embodiment the axis of rotation of the brute force gyro is constantly kept in a near perpendicular position to the flying platforms plane. The reason for that is need for maximum range of precession of the brute force gyro's axis when righting moment is applied to the axis. Righting moment is created by one servo motor mounted between the body of the stabilization apparatus and the rotational axis of the brute force gyro. Precession of the rotational axis of the brute force gyro in the perpendicular plane to the righting moment is allowed and followed by the other servo. Prolonged precession movement exhausts mechanical inertia storage capacity of the brute force gyro and affects the yaw, so in order to recover lost capacity, brute force gyro's axis has to be brought back to perpendicular position in relation to the plane of the suspended platform. That can be done using suspended platform's propulsion system, purposely creating disturbance that precesses the brute force gyro back to its original position. In the final account propulsion system of the flying platform is used to move or stabilize the craft as required and the gyro stabilizing apparatus is fulfilling role of the mechanical filter. Combinations of the gyro stabilizing apparatus and flying platform's propulsion system allows for usage of slow response reactionary engines like fans or jets and achieve high quality rigid-like mechanical response of the flying platform. Complicated electromechanical systems like deflectors and spoilers designed for quick reaction can be removed and replaced with simpler lesser quality thrust means coupled with the gyro based stabilizing apparatus. The operation of both systems coupled together will be explained in grater clarity in the next sections.

### BRIEF DESCRIPTION OF THE DRAWINGS

FIG. 1 is a perspective view of a stabilizing apparatus shown as a part of a flying platform. Included are angular displacements of a gyro and a platform.

FIG. 2 is a top view of a stabilizing apparatus shown as a part of flying platform. All major mechanical modules are shown including directions of gyro's precession.

FIG. 3 is a block diagram of a control system. Included are interconnections between a flying platform and a stabilizing apparatus.

FIG. 4 is a graph of instabilities and distribution of forces of a flying platform without a use of a stabilizing apparatus.

FIG. 5 is a graph of instabilities and distribution of forces of a flying platform with use of a stabilizing apparatus.

FIG. 6 is a cross sectional view of an embodiment one of a gyro's pivotal mounting inside stabilization apparatus.

FIG. 7 is a cross sectional view of an embodiment two of a gyro's pivotal mounting inside stabilization apparatus.

### DESCRIPTION OF PREFERRED EMBODIMENTS

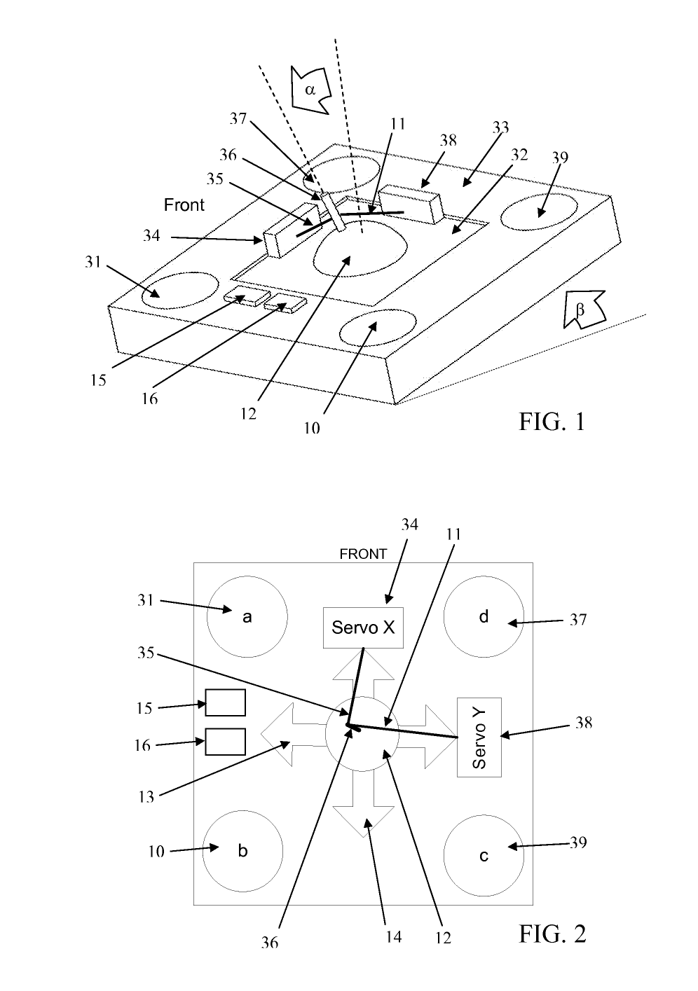

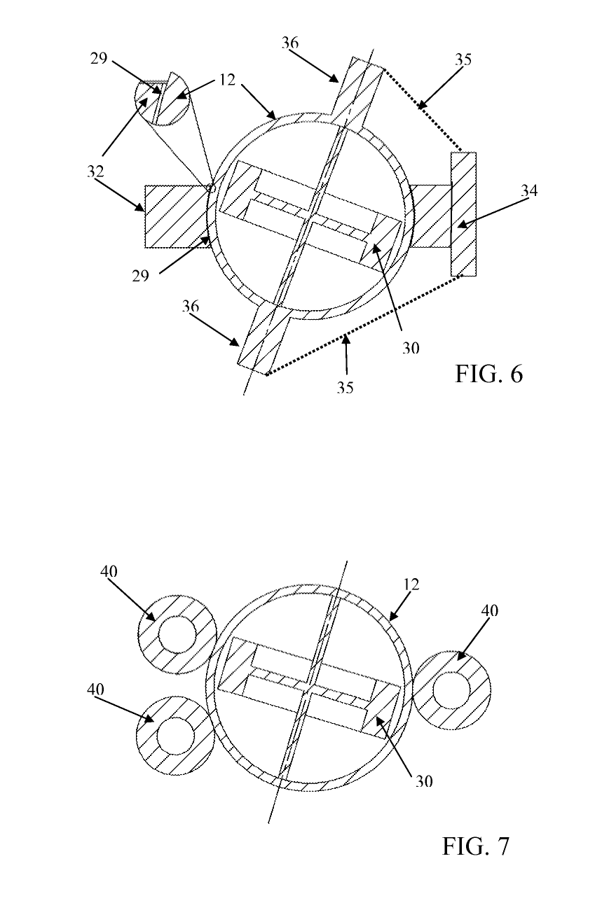

FIG. 1 shows a diagrammatic representation of the present invention. Flying platform 33 includes four lifting devices: front left ducted fan 31, front right ducted fan 37, rear left ducted fan 10 and rear right ducted fan 39. Also devices to detect flying platform's 33 tilting are shown as pitch gyroscope 15 and roll gyroscope 16. In the center of the flying platform is shown stabilization apparatus 32. It includes brute force gyro 30 mounted in the spherical compartment 12. Sphere 12 pivotally mounted in the stabilizing apparatus 32 includes studs 36 which are collinear with the brute force gyro's 30 rotational axis. FIG. 6 and FIG. 7 will explain in grater detail structure of sphere 12. Parts of the stabilizing apparatus 32 are servo 34 designed to induce pitch of the flying platform 33 and servo 38 designed to induce roll of the same. Both servos are rigidly connected to studs 36. Rigid connection is accomplished by using flexible linkages connected to the top and the bottom of stud 36. Greater detail will be shown on FIG. 6 and FIG. 7. Stabilizing apparatus 32 does not necessarily have to be mounted in the center of flying platform 33 to accomplish its function. It is obvious that part of the flying platform 33 systems will also be yaw control but for better clarity it is not described here. FIG. 1 also shows illustratively roll angle β of flying platform 33 and corresponding to it precession angle α of brute force gyro 30 enclosed within sphere 12. Meanings of both angles will be explained on FIG. 2

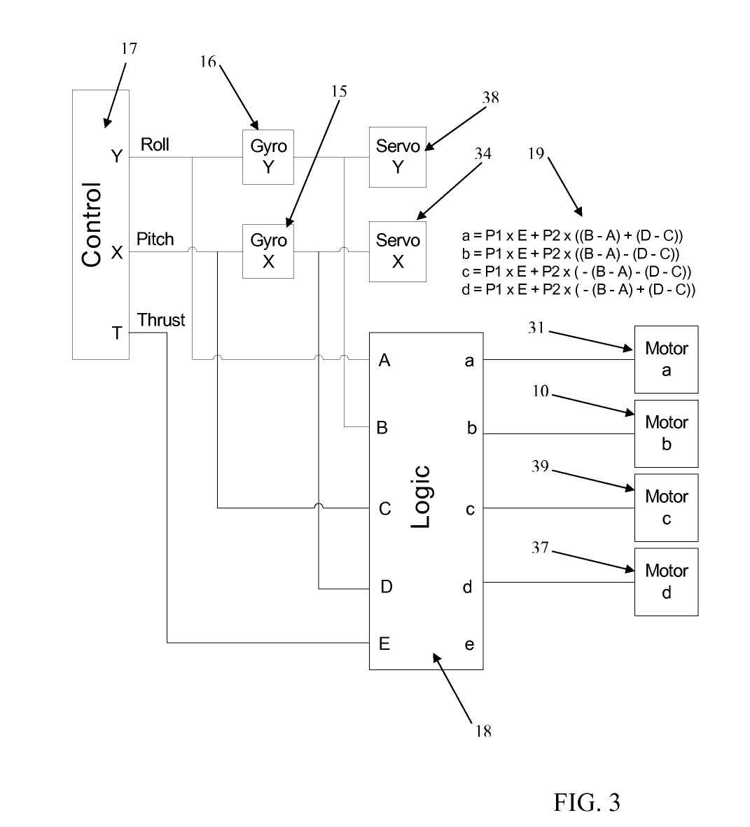

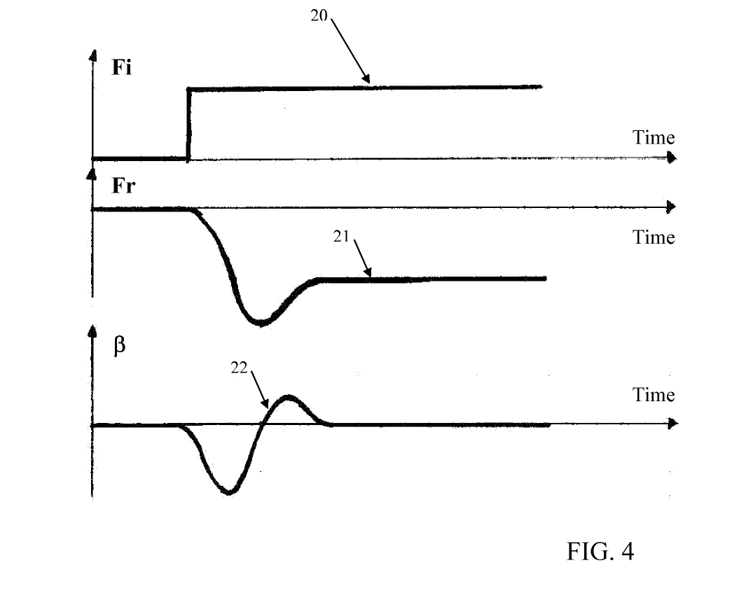

FIG. 2 and FIG. 3 explain the control systems of the flying platform 33 working in conjunction with attached to it stabilizing apparatus 32. To explain transfer functions of the logic block 18 shown on FIG. 3, lifting devices of the flying platform 33 are denoted by letters a to d also servos are marked as X and Y. To illustrate mechanical function of brute force gyro 30 mounted within sphere 12 large arrows 13 and 14 are shown on FIG. 2. Sphere 12 will precess in the direction of arrow 13 if servo 34 will apply force to stud 36 through linkage 35. Similarly if force to stud 36 is applied by servo 38 through linkage 11, sphere 12 will precess in the direction of arrow 14. Angle α from FIG. 1 is illustrated on FIG. 2 as arrow 14 and is generated by force of servo 38 to create roll angle not shown on FIG. 2. It is visible that to roll the flying platform 33 set of lifting devices 37 and 39 on the right side and set of lifting devices 31 and 10 on the left side along with the servo 38 shall be used. To pitch the flying platform correspondingly set of lifting devices 31 and 37 in the front and set of the lifting devices 39 and 10 in the back along with servo 34 will be used. System described here can work not only to induce pitch and roll but also can prevent it if the flying platform 33 would be experiencing instabilities coming from the external environment.

FIG. 3 is showing block diagram of the stabilizing apparatus 32 in the flying platform. Servo 38, servo 34 and logic module 18 are located on the stabilizing apparatus. Diagram of FIG. 3 shows interconnections between stabilizing apparatus and components of the flying platform 33. Control 17 that could be a joy-stick module, receiver or any other device governing tilt control, sends a roll requirement to the roll gyroscope 16, that signal gets also to the logic module 18, gyro 16 sends signal to servo 38 to activate it and start roll, the same signal from gyro 16 goes to the logic module 18. Similar situation takes place with the pitch signal. It leaves control 17 enters the pitch gyroscope 15 and logic module 18. Pitch signal from gyroscope 15 activates the pitch servo 34 and enters the logic module 18. Control 17 also sends the thrust signal to the logic module 18. Logic module 18 is in the heart of the stability apparatus 32, it sends the signals to the primary pitch, roll and thrust devices, in this case these are lifting devices 31, 37, 39 and 10. Transfer functions 19 shown in its most simple but descriptive form govern all the lifting devices.

FIG. 4 illustrates stability performance of a flying platform without use of described stabilizing apparatus 32. First waveform illustrates random instability created by the environment. In order to simplify the explanation instability is shown as a constant force attempting to roll the flying platform illustrated by the step function 20. Lifting devices of the flying platform will respond with a little lag and overshoot demonstrated by waveform 21. Corresponding change in the roll angle β is shown on the third waveform 22. Described response is well known in the prior art and its magnitude depends on the quality and complexity of the lifting devices. Using reaction devices like fans or jets may make deviation in β angle smaller but it will never be eliminated.

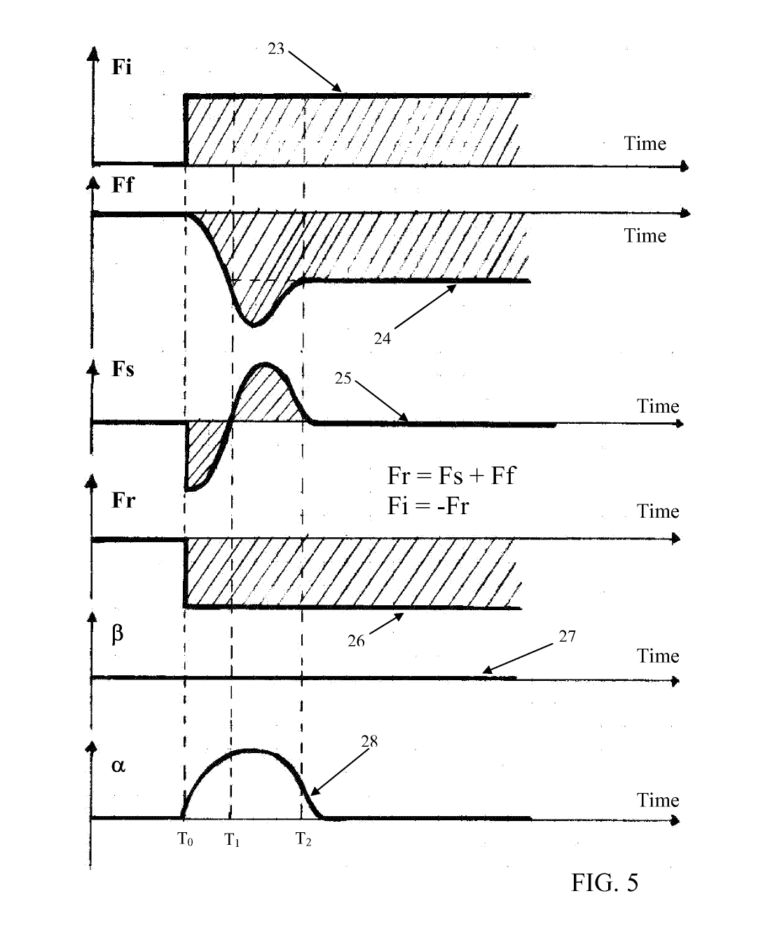

FIG. 5 describes stability performance of the flying platform 33 with stabilizing apparatus 32 attached to it. The same as in the previous case first waveform 23 illustrates instability caused by the environment. Second waveform 24 illustrates response of the lifting devices like fans or jets. There is visible lag and overshoot. Third waveform 25 illustrates response of the stabilizing apparatus 32. Fourth waveform 26 is the sum of waveforms 24 and 25. It is shown that reaction force Fr (Fr=Fs+Ff) is equal in magnitude and directly opposed to Fi. Therefore Fr=−Fi. Pitch and roll of the flying platform will be minimized to within the measurement error of the stabilization system, which is predominately determined by the accuracies of the major components, the two sensing gyros 15 and 16, as well as the two servos 38 and 34. In this case it is illustrated by the waveform 27 showing the β angle change. In the same time a angle of the precession of the sphere 12, housing brute force gyro 30, will change in similar fashion as shown by waveform 28.

Note that lag and overshoot of the primary lifting devices 31, 37, 39 and 10 is minimized by the servos 34 and 38. If the inherent lag of lifting devices is small, the size of the brute force gyro 30 can be reduced. There is a proportional relationship between the size of the brute force gyro 30 and the efficiency of the lifting devices 31, 37, 39 and 10. Purposeful overshoot of the lifting devices 31, 37, 39 and 10 in the effort to stabilize flying platform 33 is used to return the rotational axis of the brute force gyro 30 and along with it stud 36 to its original prior of instability position in relation to the flying platform 33. The home position of the brute force gyro 30 in this embodiment is substantially orthogonal to the plane of the flying platform 33 regardless of its position in relation to the ground.

FIG. 6 is the cross-sectional view of the representation of the stabilizing apparatus 32. In this embodiment brute force gyro 30 is mounted inside the sphere 12 with the rotational axis mounted collinear with the studs 36. Prior art describes in great detail ways of powering the brute force gyro 30, so it is not described here. Way of suspending pivotally and with low friction is unique. The air film 29 between the sphere 12 and the stabilizing apparatus 32 is created. It is enabled in the similar form as the ball joints are designed, only in place of liquid lubricant, air film is used. Its use provides required two degree of freedom for the sphere 12, large range of movement and low friction. Means of producing air film 29 are described by prior art. As shown earlier, servo 34 will work against the brute force gyro 30 via the linkage 35 tilting the stabilizing apparatus 32 and in the same time precessing axis of the brute force gyro 30 in the plane perpendicular to the plane showing the cross-sectional view of FIG. 6.

FIG. 7 presents cross-sectional view of the representation of another embodiment of mounting sphere 12 within the stabilizing apparatus 32. This involves using omni-directional wheel 40 similar to one described by U.S. Pat. No. 3,789,947. Omni-directional wheel 40 allows having free movements of sphere 12 in two directions with minimal friction. It would also be advantages to connect servo 34 and servo 38 to some of the omni-directional wheels 40. This function would replace linkage 35 and linkage 11. Third servo, orthogonal to servo 34 and servo 38, could be used to gain full three dimensional orientation control of brute force gyro 30.

This configuration has an advantage of easy disconnecting suspended platform 33 from the sphere 30 if required. Also there is no need for studs 36, so brute force gyro 30 could be enclosed inside the perfect sphere 12 and capable to move with no hard-coded stop. That would allow for capability of changing the modes of angular control of the suspended platform 33 by reprogramming the system. It means that apparatus would be capable of directly controlling at any time any two of three orthogonal angles defining position of flying platform 33 in the space. These angles may or may not be yaw, pitch and roll.

Stabilization apparatus 32 comprises at least two servo systems with the vectors of force substantially perpendicular to each other, working simultaneously to control orientation of the flying platform 33. Operational envelope of each servo in part affects operational envelope of the other servo, so it is necessary to build into the logic module of the servos that relationship.

Described embodiment of stabilization apparatus 32 shows pitch and roll control, it is understood that part of the propulsion system of flying platform 33, not shown here, is also a yaw control and in case of using mounting configuration for brute force gyro 30 shown on FIG. 7, that angle can also be controlled.

Obviously many modifications and variations of the present invention are possible in the light of above teachings. For example lifting devices can be jets, rocket motors, ducted fans, fans or other reactionary devices. Any number of lifting devices could be used. Also servos can be electrically or hydraulically operated. Feedback loops can vary as a result of using number of different possible transfer functions. Described invention proposes to stabilize pitch and roll but another possible embodiment can control in similar way pitch and yaw or roll and yaw or any two of three orthogonal angles selected to define orientation of flying platform 33 in the space.

It is possible to use many technological concepts to accomplish described here results. It is therefore understood that within the scope of the appended claims the invention may be practiced otherwise than as specifically described.

I claim:

1. An apparatus for controlling the orientation of a suspended platform to which it is attached, the system comprising:
A brute force gyro used as a mechanical support in controlling orientation of the suspended platform and adapted to convert the suspended platform orientation changes into a precession;
A mounting means independent of the suspended platform's propulsion system for the brute force gyro pivotally mounted in the suspended platform and without gimbals to have two degree of freedom;
At least two powered actuator means coupled between the brute force gyro's rotational axis and the suspended platform with a vectors of force substantially orthogonal to each other and each controlling tilt of the suspended platform in one plane while forcing precession in the orthogonal plane;
A control means for the powered actuators and a lifting means of the suspended platform to affect the orientation of the suspended platform and the precession of the brute force gyro by controlling the lifting means of the suspended platform.

2. An apparatus as claimed in claim 1 can be build as an integral part of the suspended platform or as a self-containing system, that can be attached to already existing suspended platform, the self-containing apparatus comprising:
Rigid frame, housing the brute force gyro and the powered actuators with the means of attachment the frame to the suspended platform;
Control input and control output means for the adaptation of the apparatus to the existing control systems of the suspended platform.

3. A suspended platform with a means of suspension by lifting devices capable to propel and tilt the suspended platform, comprising:
Moment of inertia of the suspended platform itself, excluding a brute force gyro must be substantially close to zero;
Center of gravity of the suspended platform must be substantially close to the thrust vector attachment of the lifting means.

4. The mounting means for the brute force gyro pivotally mounted in a frame and without gimbals having two degree of freedom as described in claim 1, comprising:
Compartment for the brute force gyro in a form of a sphere with the brute force gyro rigidly mounted inside the sphere;
Pivotal mounting means of the sphere inside the frame and for low friction between the sphere and the frame, creation an air film.

5. The mounting means for the brute force gyro pivotally mounted in a frame and without gimbals having two degree of freedom as described in claim 1 and with the use of plurality of omni-directional wheels similar to one described by U.S. Pat. No. 3,789,947, comprising:
Compartment for the brute force gyro in a form of a sphere with the brute force gyro rigidly mounted inside the sphere;
Plurality of omni-directional wheels for pivotal mounting of the sphere;
At least two of the omni-directional wheels are fulfilling function of the powered actuators described in claim 1.

6. Capability of shifting the modes of angular control by adaptability of the programming means of the apparatus described in claim 1 and with the brute force gyro with the mounting means described by claim 5.
